(19) United States
(12) Patent Application Publication
(10) Pub. No.: US 2011/0102929 A1
(43) Pub. Date: May 5, 2011

(54) DISK DRIVE AND METHOD OF TIMING CONTROL FOR SERVO-DATA DETECTION

(76) Inventors: Masaharu KANNO, Kanagawa (JP); Yosuke Hamada, Kanagawa (JP); So Ogiwara, Kanagawa (JP); Tatsuya Katoh, Kanagawa (JP); Masahiro Shimizu, Kanagawa (JP)

(21) Appl. No.: 12/608,930

(22) Filed: Oct. 29, 2009

(30) Foreign Application Priority Data
Oct. 29, 2009 (JP) 2008-278924

(51) Int. Cl. G11B 5/09

(52) U.S. Cl. 360/51; G9B/5.033

(57) ABSTRACT

A method of timing control for servo-data detection in a disk drive. The method includes retrieving a plurality of servo sectors arranged discretely in a circumferential direction of a disk and measuring time intervals between servo sectors. The method also includes determining in which zone of a plurality of preset zones each of the measured time intervals is included. Moreover, the method also includes determining variations in time intervals from the zones of a plurality of previous time intervals, and modifying timing for servo-sector detection if variations in time intervals are within a preset range.

### CROSS-REFERENCE TO RELATED APPLICATION

This application claims priority from the Japanese Patent Application No. 2008-278924, filed Oct. 29, 2008, the disclosure of which is incorporated herein in its entirety by reference.

### TECHNICAL FIELD

Embodiments of the present invention relate to a disk drive and a method of timing control for servo-data detection.

### BACKGROUND

Disk drives using various kinds of disks, such as optical disks, magneto-optical disks, flexible magnetic-recording disks, similar disks for data-storage are known in the art. In particular, hard disk drives (HDDs) have been widely used as data-storage devices that have proven to be indispensable for contemporary computer systems. Moreover, HDDs have found widespread application to motion picture recording and reproducing apparatuses, car navigation systems, cellular phones, and similar devices, in addition to computers, because of the outstanding information-storage characteristics of HDDs.

FIG. 11 is a diagram that schematically depicts a data structure of the recording surface of a magnetic-recording disk 11. On the recording surface of the magnetic-recording disk 11, multiple servo areas 111 extend radially in the radial direction from the center of the magnetic-recording disk 11 and are disposed discretely at specific angles; and, data areas 112 are formed between two adjacent servo areas 111. In each servo area 111, servo data for performing position control of a head-slider 12 is recorded. In each data area 112, user data is recorded.

On the recording surface of the magnetic-recording disk 11, multiple data tracks having a specific width in the radial direction are formed concentrically. User data is recorded along data tracks. A data track includes a data sector, which is a recording unit of user data; and, a data track typically includes multiple data sectors. Typically, a plurality of data tracks are grouped into a plurality of zones 113a to 113c in accordance with the radial positions of data tracks on the magnetic-recording disk 11. The number of data sectors that is included in a data track is set for each of the zones.

Similarly, the magnetic-recording disk 11 includes multiple concentric servo tracks having a specific width in the radial direction. Each servo track includes multiple servo sectors separated by data areas, for example, data area 112. At a radial position in a servo area 111, a single servo sector is present. A servo sector includes a preamble, a servo address mark, a servo-track number, a servo-sector number in the servo track, and a burst pattern for fine position control. The burst pattern includes, for example, four kinds of burst patterns, A, B, C, and D, which are located at different radial positions. In accordance with the amplitude of read-back signals of each burst pattern, the position on the servo track can be determined.

A HDD reads servo data with a head-slider flying in proximity to the recording surface of the magnetic-recording disk to position the head-slider at a designated target radial position. A HDD reads, or alternatively, writes user data, for example, by performing reading and writing operations, with the head-slider.

A HDD reads servo data and reads and writes user data with a head-slider and a channel circuit. The HDD performs timing control of servo-data processing and user data processing to perform respective processes in sequential periods, or alternatively, in different periods. The head-slider and the channel circuit switch between servo-data processing and user-data processing in accordance with timing-control signals from a controller.

To detect servo data on a magnetic-recording disk with accuracy and reliably, the timing signal for controlling servo-data processing is controlled with proper timing. When the time intervals between servo sectors are exactly constant, the controller turns ON the timing signal at preset regular time intervals to allow accurate detection and reading of servo data. However, the actual time intervals between servo sectors are not constant, and vary depending on the position of the servo sector in the circumferential direction. Thus, engineers and scientists engaged in the development of magnetic-recording technology are interested in further developing servo-control systems to control the effects of timing variations that may affect the high levels of reliability that have come to be expected by consumers in the market for HDDs.

### SUMMARY

Embodiments of the present invention include a method of timing control for servo-data detection in a disk drive. The method includes retrieving a plurality of servo sectors arranged discretely in a circumferential direction of a disk and measuring time intervals between servo sectors. The method also includes determining in which zone of a plurality of preset zones each of the measured time intervals is included. Moreover, the method also includes determining variations in time intervals from the zones of a plurality of previous time intervals, and modifying timing for servo-sector detection if variations in time intervals are within a preset range.

### DESCRIPTION OF THE DRAWINGS

The accompanying drawings, which are incorporated in and form a part of this specification, illustrate embodiments of the invention and, together with the description, serve to explain the embodiments of the present invention:

FIG. 1 is a block diagram schematically depicting a configuration of a hard-disk drive (HDD), in accordance with an embodiment of the present invention.

FIG. 2 is a diagram schematically depicting servo sectors forming a portion of a servo track and a data format of a servo sector, in accordance with an embodiment of the present invention.

FIG. 3 is a chart schematically depicting the timing of the servo gate SG and the search window SW, in accordance with an embodiment of the present invention.

FIG. 4 is a diagram schematically depicting servo gates SGs with different timings, in accordance with an embodiment of the present invention.

FIG. 5 is a chart schematically depicting the timing relationship between SAM detection, rise and fall of the servo gate SG, and rise and fall of the search window SW, in accordance with an embodiment of the present invention.

FIG. 6 is a diagram illustrating a method for determining a variation in time interval, in accordance with an embodiment of the present invention.

FIG. 7 is a diagram schematically illustrating variations in distance R between each servo sector, the spindle center, and servo-sector time interval TS caused by disk shift, in accordance with an embodiment of the present invention.

FIG. 8 is a functional block diagram illustrating a specific method of servo-timing control, in accordance with an embodiment of the present invention.

FIG. 9 is a flowchart illustrating a specific method of servo-timing control, in accordance with an embodiment of the present invention.

FIG. 10 is a diagram depicting an example method for determining variations in time intervals, in accordance with an embodiment of the present invention.

FIG. 11 is a diagram schematically depicting a data structure of the recording surface of a magnetic-recording disk, as is known in the art.

The drawings referred to in this description should not be understood as being drawn to scale except if specifically noted.

### DESCRIPTION OF EMBODIMENTS

Reference will now be made in detail to the alternative embodiments of the present invention. While the invention will be described in conjunction with the alternative embodiments, it will be understood that they are not intended to limit the invention to these embodiments. On the contrary, the invention is intended to cover alternatives, modifications and equivalents, which may be included within the spirit and scope of the invention as defined by the appended claims.

Furthermore, in the following description of embodiments of the present invention, numerous specific details are set forth in order to provide a thorough understanding of the present invention. However, it should be noted that embodiments of the present invention may be practiced without these specific details. In other instances, well known methods, procedures, and components have not been described in detail as not to unnecessarily obscure embodiments of the present invention. Throughout the drawings, like components are denoted by like reference numerals, and repetitive descriptions are omitted for clarity of explanation if not necessary.

### DESCRIPTION OF EMBODIMENTS OF THE PRESENT INVENTION FOR A DISK DRIVE AND A METHOD OF TIMING CONTROL FOR SERVO-DATA DETECTION

With relevance to embodiments of the present invention, there are two major causes of the variations in time intervals between servo sectors. One is disk shift. Disk shift is a phenomenon wherein the center of a magnetic-recording disk secured to a spindle motor is offset from the rotational center of the spindle. For example, disk shift may be caused by an external impact of the HDD. Moreover, when the temperature within a HDD changes drastically, the difference in expansion rate of mechanical components forming the HDD may cause an offset of the center of the magnetic-recording disk from the center of the spindle shaft. When the magnetic-recording disk is offset from the spindle shaft, the center for writing servo data, which is the center of a servo track, is offset from the rotational center of the magnetic-recording disk. Consequently, the time intervals between servo sectors in a servo track vary, as a result of disk shift.

With further relevance to embodiments of the present invention, another major cause of the variations in time intervals between servo sectors is the rotational fluctuations of the spindle motor. A contemporary spindle motor mounted on an HDD includes a fluid dynamic bearing mechanism. The characteristics of oil used in the fluid dynamic bearing change with the temperature within the HDD. In particular, when the HDD is started up at a low temperature, the time intervals between servo sectors fluctuate until the viscosity of the oil at the initially low temperature is stabilized. If the HDD controls a servo-gate signal, ignoring such variations in time intervals between servo sectors will cause the HDD to be unable to detect servo sectors, resulting in an error. Hence, control methods for the servo-gate signal to cope with variations in time intervals between servo sectors caused by disk shift have been proposed, as known in the art.

With further relevance to embodiments of the present invention, measuring intervals between servo sectors on a whole track and calculating the shift amount at every sector, which gives the variation in every interval, allow more accurate timing control conforming to disk shift. However, measuring all servo-sector intervals consumes much time. Moreover, calculation of a shift amount utilizes large amounts of computational processing. Even though these operations might be able to be performed at a start-up, these operations cannot be performed while processing host commands after the start-up. Hence, variations in time intervals occurring after the start-up, like the variations in time intervals between servo sectors caused by the viscosity of the oil, are difficult to cope with. Thus, embodiments of the present invention provide a technique that can efficiently and accurately cope with variations in servo sector intervals as the situation arises in operation of the HDD.

Embodiments of the present invention include a method of timing control for servo-data detection in a disk drive. This method reads a plurality of servo sectors arranged discretely in a circumferential direction of a disk and measures time intervals between servo sectors. The method also determines in which zone of a plurality of preset zones each of the measured time intervals is included. Moreover, the method determines variations in time intervals from the zones of a plurality of previous time intervals, and modifies timing for servo-sector detection if the variations in time intervals are within a preset range. According to the efficient process of this method, the tracking of the timing of the variations in servo-sector intervals can be enhanced while maintaining the reliability of timing control.

In an embodiment of the present invention, the modification of the timing modifies the start time of retrieving a servo sector. Thus, in an embodiment of the present invention, this allows modification of the timing in the reading process of a servo sector and there is no need for increasing the time period for servo processing. In another embodiment of the present invention, a time interval between servo sectors is measured by measuring the time period between the start time of retrieving a servo sector and detection of a specific signal in the servo sector. Thus, in an embodiment of the present invention, efficient measurement of the amounts of the mismatches between the sector intervals and the current timing can be provided.

In one embodiment of the present invention, the plurality of zones includes a negative zone where the difference between each value and a reference value is in a negative value range, and a positive zone where the difference between each value and a reference value is in a positive value range; and, the variations in time intervals are determined from a number of times that the time intervals are included in the negative zone and the number of times that the time intervals are included in the positive zone. Thus, in an embodiment of the present invention, the tracking of the variations in servo-sector intervals and the reliability of servo-data detection can be attained through an efficient process. In another embodiment of the present invention, the plurality of zones includes a zone zero which is defined by a value whose difference from the reference value is positive and a value whose difference from the reference value is negative, and a variation in a time interval is neglected if the measured time interval is included in the zone zero. Thus, in an embodiment of the present invention, reliability is enhanced.

In one embodiment of the present invention, if a measured time interval is included in the positive zone, a count is made in one of a direction selected from the group consisting of a direction of an increment and a direction of a decrement; if a measured time interval is included in the negative zone, a count is made in the other direction to a direction selected if a measured time interval is included in said positive zone; and if a measured time interval is included in the zone zero, counting is skipped; and, then if the count value reaches a preset value in the one direction, the timing is delayed; and if the count value reaches a preset value in the other direction, the timing is advanced. Thus, in an embodiment of the present invention, the tracking of the variations in servo-sector intervals and the reliability of servo-data detection can be attained through an efficient process.

In another embodiment of the present invention, the plurality of zones include a negative zone where the difference between each value and a reference value is in a negative value range and a positive zone where the difference between each value and a reference value is in a positive value range; and, zones disposed farther from the reference value are weighted more; and, the variations in time intervals are determined from the number of times that measured time intervals are included in each zone, and from a weight. Thus, in an embodiment of the present invention, tracking of the variations in servo-sector intervals is facilitated.

In another embodiment of the present invention, the rate of change in time intervals is determined from a plurality of measured time intervals and the preset zones are modified in accordance with the result of the determination. Thus, in an embodiment of the present invention, tracking of the variations in servo-sector intervals is facilitated.

In accordance with embodiments of the present invention, a disk drive includes a disk having a plurality of servo sectors arranged discretely in a circumferential direction, a head for retrieving the servo sectors from disk in rotation, a measuring unit for measuring a time interval between servo sectors read by the head, a zone-determination unit for determining in which zone of a plurality of preset zones the time interval measured by the measuring unit is included, and a timing-adjustment unit for determining variations in time intervals from the zones of a plurality of previous time intervals, and for modifying the timing for servo-sector detection if the variations in time intervals is within a preset range. Thus, in an embodiment of the present invention, the tracking of the timing of the variations in servo-sector intervals can be enhanced while maintaining the reliability of timing control through an efficient process.

In accordance with embodiments of the present invention, an efficient process with more precise detection of servo sectors on a disk is provided. An example in which embodiments of the present invention have been applied to a HDD, as an example of a disk drive, is subsequently described.

One embodiment of the present invention includes timing control for detecting servo sectors on a magnetic-recording disk. In accordance with embodiments of the present invention, the HDD measures time intervals between servo sectors during a tracking operation for reading, or writing, user data and controls timing signals for detecting servo sectors in accordance with the measured results. In accordance with embodiments of the present invention, the HDD determines in which zone of the preset zones each of measured time intervals is to be included. In accordance with embodiments of the present invention, the HDD determines variations in time intervals from the zones of a plurality of previous time intervals and modifies the timing of servo-sector detection if the variations in time intervals are in a specific range. In accordance with embodiments of the present invention, a process achieves adjustment of the timing depending on the variations in time intervals between servo sectors. A configuration of a HDD, in accordance with embodiments of the present invention, is next described.

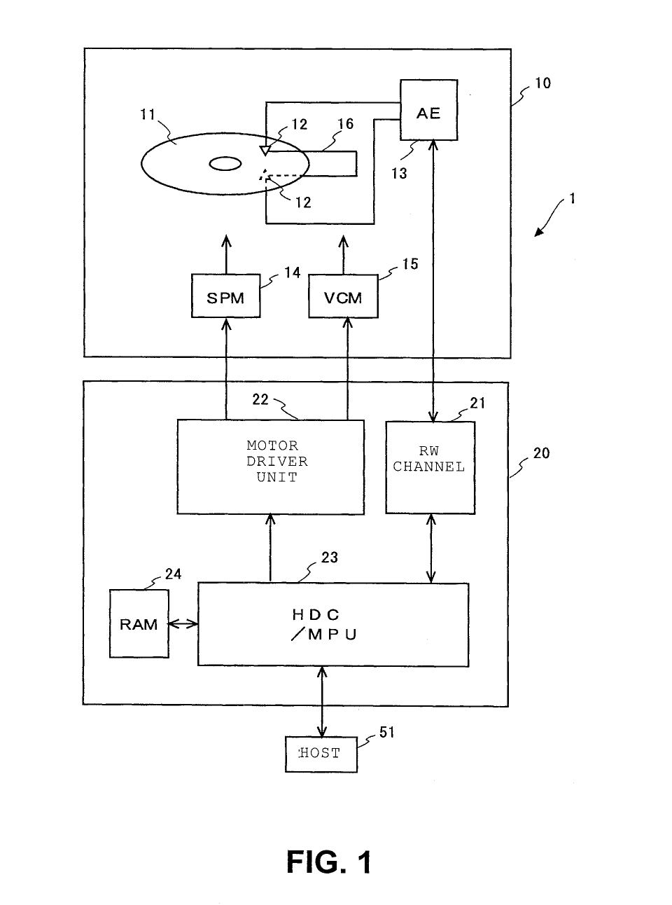

With reference now to FIG. 1, in accordance with an embodiment of the present invention, a block diagram is shown that schematically depicts a configuration of HDD 1. HDD 1 includes a magnetic-recording disk 11, which is a disk for storing data, inside a disk enclosure (DE) 10. A spindle motor (SPM) rotates the magnetic-recording disk 11 at a specific angular rate. Head-sliders 12 are provided to access the magnetic-recording disk 11; each of the head-sliders 12 corresponds to each recording surface of the magnetic-recording disk 11. As used herein, “access” is a term of art that refers to operations in seeking a data track of a magnetic-recording disk and positioning a magnetic-recording head on the data track for both reading data from, and writing data to, a magnetic-recording disk. Each head-slider 12 includes a slider for flying in proximity to the recording surface of the magnetic-recording disk and a magnetic-recording head which is affixed to the slider and converts magnetic signals to and from electrical signals.

Head-sliders 12 are affixed to a distal end of an actuator 16. The actuator 16, which is coupled to a voice-coil motor (VCM) 15, rotates on a pivot shaft to move the head-sliders 12 in a nominally radial direction of the magnetic-recording disk 11 in proximity with the recording surface of the magnetic-recording disk 11, as the magnetic-recording disk 11 rotates. The actuator 16 and the VCM 15 provide moving mechanisms for the head-sliders 12.

On a circuit board 20 outside the DE 10, circuit elements are mounted. A motor driver unit 22 drives the SPM 14 and the VCM 15 in accordance with control data from a head-disk controller/microprocessor unit (HDC/MPU) 23. A random access memory (RAM) 24 functions as a buffer for temporarily storing read data and write data. An arm-electronics (AE) module 13 inside the DE 10 selects a head-slider 12 to access the magnetic-recording disk 11 from multiple head-sliders 12, amplifies read-back signals from the head-sliders 12, and sends the read-back signals to a read-write channel (RW channel) 21. In addition, arm-electronics (AE) module 13 sends write signals from RW channel 21 to a selected head-slider 12.

RW channel 21, in a read operation, amplifies read-back signals supplied from AE module 13 to have specific amplitude, extracts data from the obtained read-back signals, and decodes the read-back signals. The read data includes user data and servo data. The decoded read user data and servo data are supplied to HDC/MPU 23. RW channel 21, in a write operation, code-modulates write data supplied from HDC/MPU 23, converts the code-modulated data into write signals, and then supplies the write signals to AE module 13. RW channel 21 reads servo data and reads, or writes, user data in accordance with timing control signals from HDC/MPU 23.

HDC/MPU 23, which is an example of a controller, performs control of HDD 1 in addition to necessary processes concerning data processing such as: reading and writing operation control; command execution order management; positioning control of the head-sliders 12 using servo signals, which is referred to by the term of art “servo control;” interface control to and from a host 51; defect management; and, error handling when any error has occurred. In one embodiment of the present invention, HDC/MPU 23 measures servo-sector intervals while performing normal operations in response to commands from the host 51, and controls timing signals for servo-data detection in accordance with the measured results.

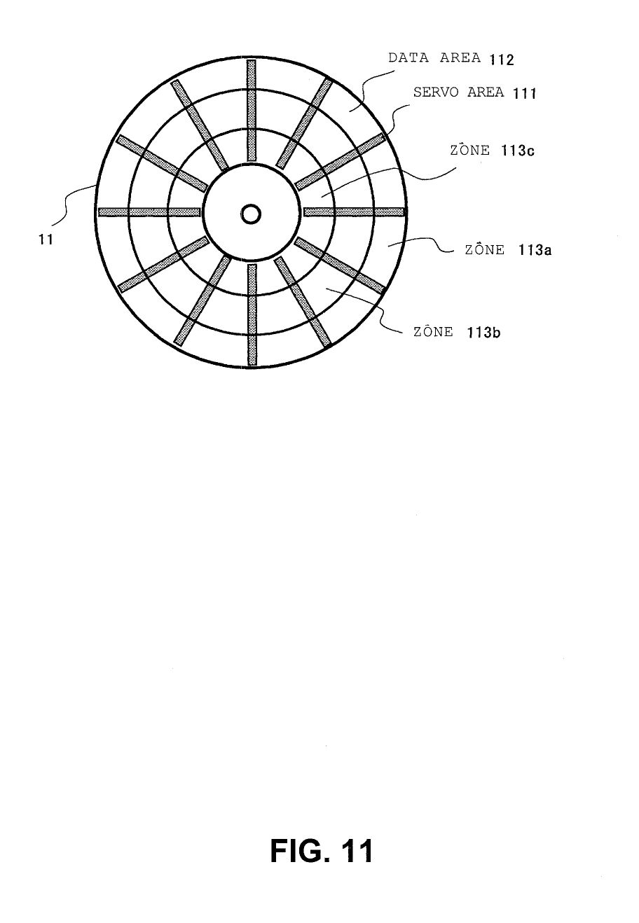

As previously described with reference to FIG. 11, the recording surface of the magnetic-recording disk 11 is provided with a plurality of servo areas extending from the center of the magnetic-recording disk 11 in the radial direction, which are formed discretely at specific angles, and data areas between two adjacent servo areas. Each servo area includes a plurality of servo sectors arranged continuously in the radial direction of the magnetic-recording disk 11. A servo track is composed of the set of servo sectors included in one full rotation of the magnetic-recording disk 11; and, the servo sectors are discrete from each other in the circumferential direction.

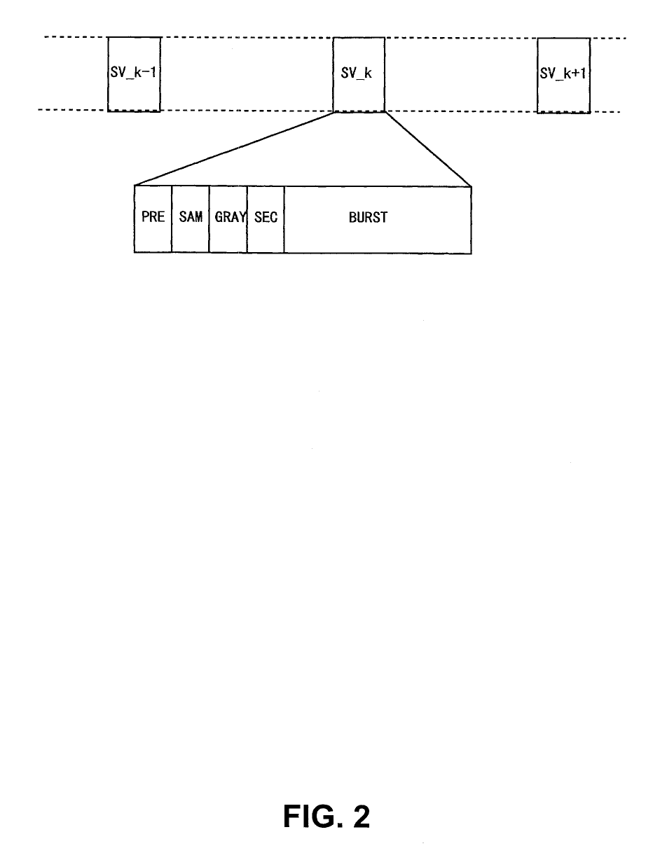

With reference now to FIG. 2, in accordance with an embodiment of the present invention, a diagram is shown that schematically depicts servo sectors forming a portion of a servo track and a data format of a servo sector. FIG. 2 shows three consecutive servo sectors SV_k−1, SV_k, and SV_k+1. A head-slider 12 flies from the left of the drawing toward the right and sequentially reads servo sectors SV_k−1, SV_k, and SV_k+1 in this order. In the example of FIG. 2, each servo sector includes: a preamble (PRE), a servo-address mark (SAM), a track identification (ID) formed of gray codes (GRAY), a servo-sector number (SEC), and a burst pattern (BURST).

The preamble is a field for absorbing small rotational fluctuations and adjusting gains of a preamplifier. The SAM is a field including a dibit pulse and indicates the beginning of actual information, for example, the track ID number. In one embodiment of the present invention, HDD 1 measures time intervals between servo sectors using the detection time of the SAM. In another embodiment of the present invention, the detection time of SAM is used to make an accurate measurement; but, detection time of other data, for example, signals, may be used in the measurement. The track ID is data for identifying a servo track; and, the servo-sector number is data for identifying a servo sector in a servo track. The burst pattern (BURST) is signals for indicating a more precise position of the servo track indicated by a track ID, and the present example includes four amplitude signals A, B, C, and D which are written staggered, namely, written in such a manner that the four signals on four respective tracks are slightly shifted from each other in the radial direction. HDC/MPU 23 can locate a servo-track position from the track ID in a servo sector, and further, a precise radial position on the track from the burst pattern. The position in the circumferential direction can be ascertained from the servo-sector number.

Several types of servo-sector format are known in the art, those that include a format without servo-sector numbers, and a format having fields for storing information about periodic vibration, which causes repeatable run-out (RRO), in addition to the above-mentioned fields. Embodiments of the present invention can be applied to HDDs using servo sectors in any format.

AE module 13 and RW channel 21 perform operations in accordance with timing signals from HDC/MPU 23. In servo-data processing, HDC/MPU 23 uses timing signals of a servo gate SG and a search window SW. The servo gate SG is a switching signal of servo-processing mode; while this signal is HIGH, AE module 13 and RW channel 21 are in servo-processing mode to read servo data. The search window SW is a timing signal to search for, which is to detect, the SAM in a servo sector. If RW channel 21 cannot detect a SAM while the search window SW is HIGH, RW channel 21 notifies HDC/MPU 23 of an error of non-detection of a SAM.

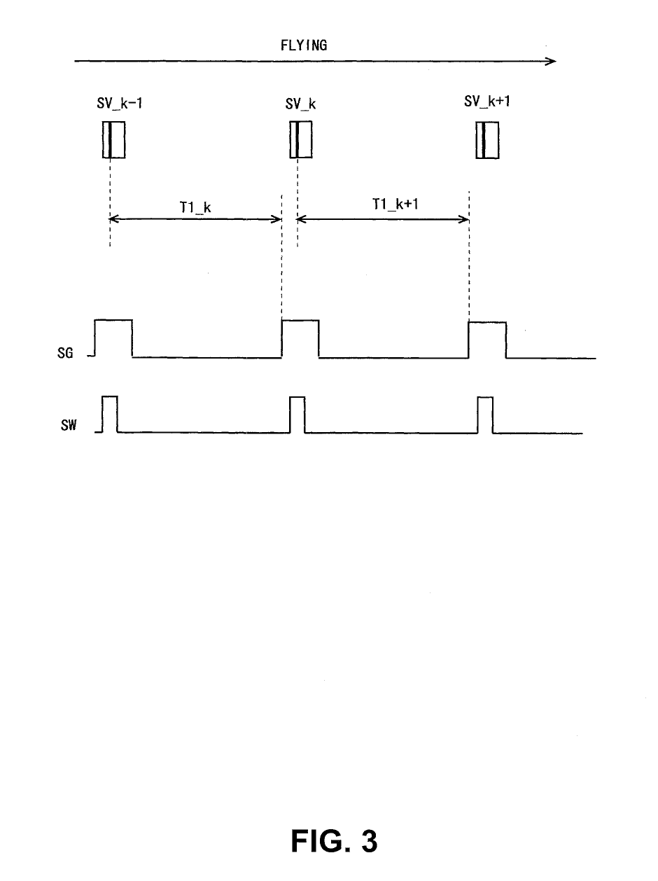

With reference now to FIG. 3, in accordance with an embodiment of the present invention, a chart is shown that schematically illustrates the timing of the servo gate SG and the search window SW. HDC/MPU 23 opens the servo gate SG (HIGH) immediately before a head-slider 12 reaches a servo sector. Upon completion of reading of the servo sector, HDC/MPU 23 closes the servo gate SG (LOW). When a specific time period has passed after HDC/MPU 23 turned the servo gate SG into HIGH, HDC/MPU 23 opens the search window SW (HIGH); and, when a specific time period has passed, HDC/MPU 23 closes the search window SW (LOW). If RW channel 21 detects a SAM while the search window SW is open, RW channel 21 performs further servo-data processing on the basis of the time of the detection. RW channel 21 notifies HDC/MPU 23 of the time of the SAM detection; and, HDC/MPU 23 controls the servo gate SG on the basis of the time. For example, when a time period T1 has passed from a detection of the SAM of a servo sector, HDC/MPU 23 turns the servo gate ON (HIGH) for the next servo sector. The suffixes attached to the T1's in FIG. 3 correspond to servo sectors. HDC/MPU 23 measures time intervals between servo sectors, and modifies the timing of the servo gate SG based on the measured results. The modification of the timing of the servo gate SG causes a change in the timing of the search window SW.

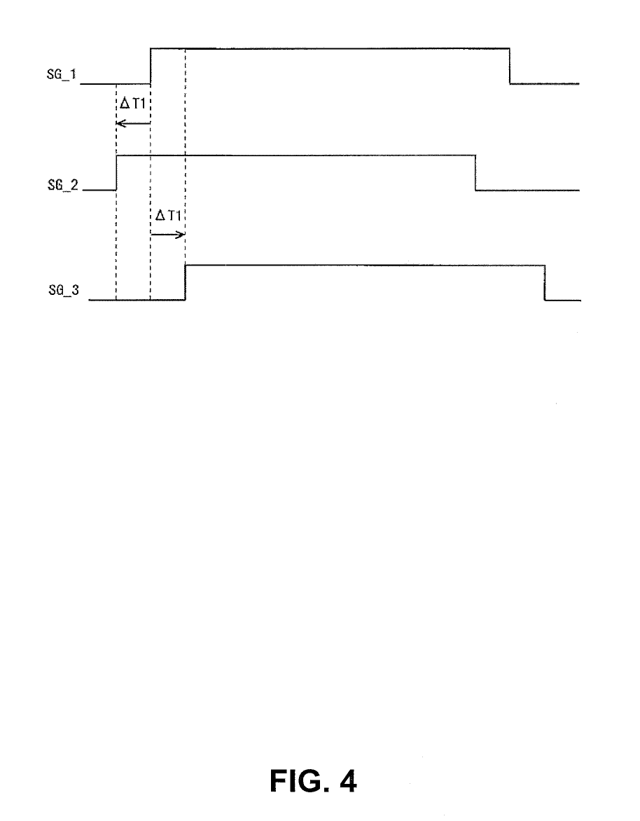

With reference now to FIG. 4, in accordance with an embodiment of the present invention, a diagram is shown that schematically depicts servo gates SGs different in timing. Compared with the current servo gate SG_1, a servo gate SG_2 opens earlier by ΔT1, for example, 50 nanoseconds (ns). On the other hand, a servo gate SG_3 opens later than the current servo gate SG_1 by ΔT1. If the measured time intervals between servo sectors are short, HDC/MPU 23 advances a rising edge of the servo gate; and if long, HDC/MPU 23 delays the rising edge of the servo gate. This allows more accurate servo-data reading conforming to variations in time intervals between servo sectors caused by disk shift, or alternatively, rotational fluctuations of the spindle. HDC/MPU 23 may change the amount of timing modification in accordance with the measured results. Examples of such control are subsequently described. Herein, in one embodiment of the present invention, a control method is subsequently described in which the time to be adjusted by HDC/MPU 23 for the servo gate SG is a fixed value, ΔT1. The method provides efficient processing in timing control for servo-data detection. In an embodiment of the present invention, HDC/MPU 23 adjusts the timing of the servo gate SG and the search window SW on the basis of the time of SAM detection.

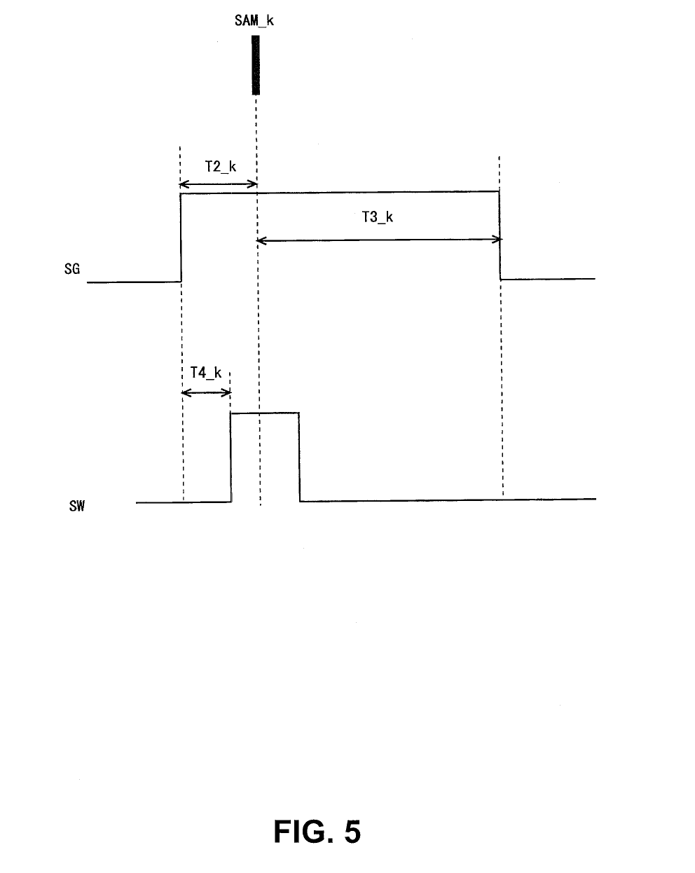

With reference now to FIG. 5, in accordance with an embodiment of the present invention, a chart is shown that schematically illustrates the timing relationship among the time of SAM detection, rising edges and falling edges of the servo gate SG, and rising edges and falling edges of the search window SW. As described with reference to FIG. 3, HDC/MPU 23 determines the timing of a rising edge of the servo gate SG on the basis of the timing of SAM detection in a read servo sector, which is typically the first previous sector. HDC/MPU 23 determines the timing of a rising edge of the search window SW on the basis of the timing of the rising edge of the servo gate SG. The interval T4_k between the rising edge of the servo gate SG and the rising edge of the search window SW is constant regardless of servo sectors. Moreover, the time period while the search window SW is open (at HIGH) is a constant value. The suffixes attached to T2 to T4 in FIG. 5 correspond to servo sectors.

HDC/MPU 23 closes the servo gate SG when T3_k has passed after the detection of the SAM in a servo sector SV_k. The T3_k is also a fixed value and constant. In this regard, the T3_k, T4_k, and the time period while the search window SW is open may be changed depending on measured servo-sector intervals. In this way, HDC/MPU 23 opens the servo gate SG when T1_k has passed after the detection of the SAM in a servo sector SV_k−1. Furthermore, HDC/MPU 23 opens the search window SW when T4_k has passed after the rise of the servo gate SG. If HDC/MPU 23 detects the SAM in the servo sector SV_k, HDC/MPU 23 closes the servo gate SG when T3_k has passed after the detection.

HDC/MPU 23 measures the time period T2_k from the rising edge of the servo gate SG to the SAM detection to measure the time interval between servo sectors. As described above, HDC/MPU 23 opens the servo gate SG on the basis of the time of the detection of the SAM in the first previous servo sector. The time interval between the rising edge of the servo gate SG and the detection of the SAM in the first previous servo sector is the specific time period T1_k.

HDC/MPU 23 modifies this time period T1_k. Then, the time period T2_k indicates the time interval between servo sectors on the basis of the current timing, which corresponds to the rising edge, of the servo gate SG. Thus, in an embodiment of the present invention, HDC/MPU 23 is able to ascertain easily whether the current timing of the servo gate SG is within an appropriate range for the actual time interval between servo sectors.

HDC/MPU 23 and RW channel 21 can perform time measurement and timing control of signals using, for example, a clock signal generated by RW channel 21. The cycle of the clock signal is small enough for the time periods for timing control in servo-data processing.

In an embodiment of the present invention, HDC/MPU 23 controls the timing of the servo gate based on, not only the first previous servo-sector interval, but also a plurality of previous servo-sector intervals. Specifically, HDC/MPU 23 determines whether, or not, to modify the servo-gate timing from a plurality of previous measured time intervals between servo sectors. In one embodiment of the present invention, HDC/MPU 23 determines in which zone each of the plurality of previous measured time intervals is included, and determines the variations in time intervals from the determined results. This provides an efficient process to determine the variations in time intervals. If the variations in time intervals are in a specific range which indicates that the variations in time intervals are disproportionately large in one direction, HDC/MPU 23 modifies the timing of the servo gate SG.

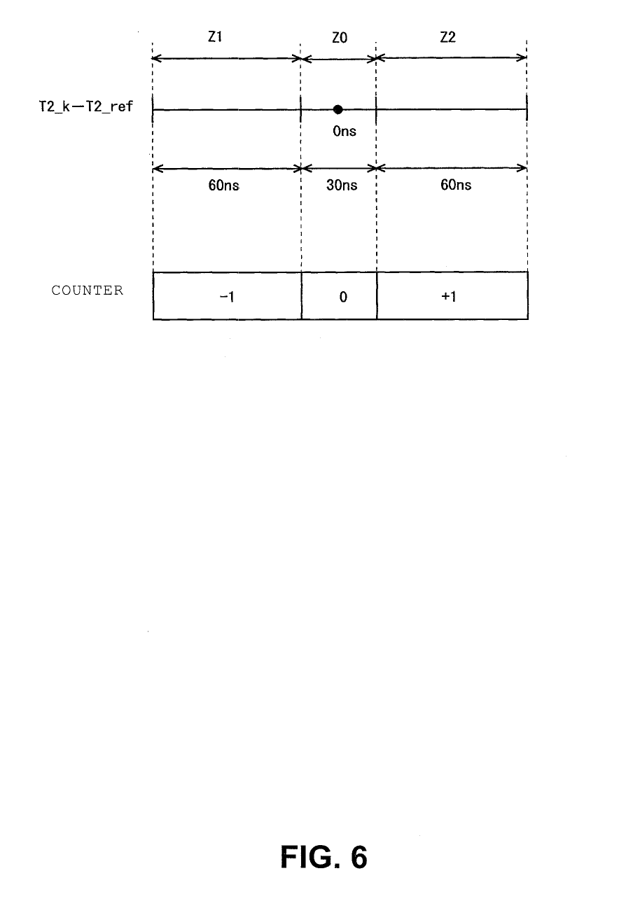

With reference now to FIG. 6, in accordance with an embodiment of the present invention, a drawing is shown that illustrates an example of a determination method employing HDC/MPU 23. HDC/MPU 23 ascertains the shift amount (T2_k−T2_ref) of the time period T2_k between the rising edge of the servo gate SG and the SAM detection from a preset reference value T2_ref. Determining which zone of the preset zones the shift belongs to determines the zone corresponding to the measured time interval. In the example of FIG. 6, three zones Z0 to Z2 are defined: a zone Z0 for the shift amount of ±15 ns, a negative zone Z1 for the shift amount from −15 nm to −75 nm, and a positive zone Z2 for the shift amount from +15 nm to +75 nm.

HDC/MPU 23 includes a counter, which corresponds to a variable. If the shift amount of T2_k ranges in the zone Z1, HDC/MPU 23 decrements the counter. The count to be decremented is, for example, by one unit. If the shift amount of T2_k ranges in the zone Z2, HDC/MPU 23 increments the counter. The unit of count to be incremented is, for example, one unit. If the shift amount of T2_k ranges in the zone Z0, HDC/MPU 23 does not alter the counter, which corresponds to skipping the count, but maintains the count value constant. In this regard, either an increment, or a decrement, is allowable in both positive and negative zones as long as the count direction differs depending on the zone.

If the count value reaches a positive threshold, HDC/MPU 23 delays the timing of the servo gate SG by ΔT1, for example, by 50 ns. The range exceeding the positive threshold level is a preset range to modify, which is to delay, the timing of the servo gate SG. On the other hand, when the count value reaches a negative threshold, HDC/MPU 23 advances the timing of the servo gate SG by ΔT1. The range exceeding the negative threshold level is another preset range to modify, which is to advance, the timing of the servo gate SG.

The positive and negative threshold levels are, for example, +3 and −3, respectively. When HDC/MPU 23 modifies the timing of the servo gate SG, HDC/MPU 23 clears the counter. The values defining the zones, the unit count in manipulating the counter, and the threshold levels for defining the preset ranges to modify the timing of the servo gate SG in the above description are by way of example only, and appropriate values are used depending on the design of HDD 1. In an embodiment of the present invention, the values are symmetric between positive and negative values as in the above example.

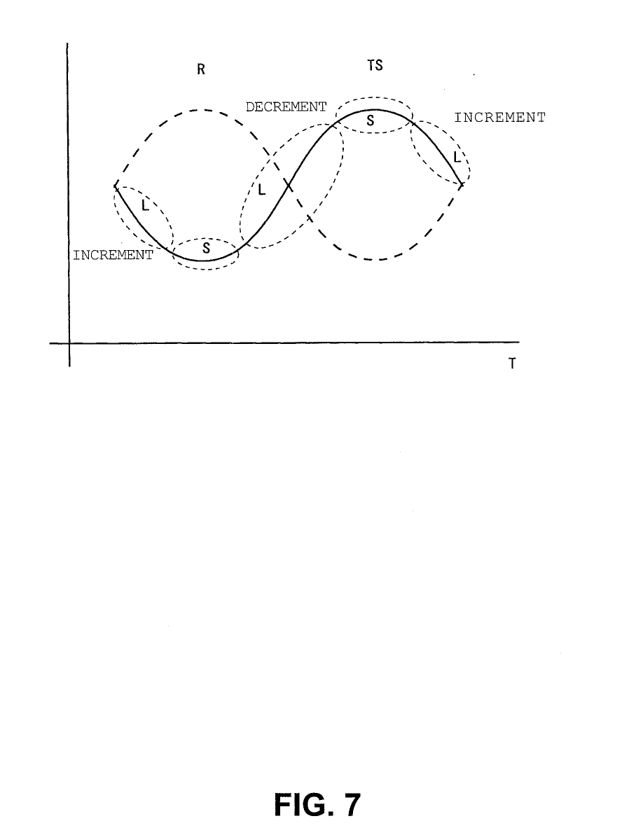

With reference now to FIG. 7, in accordance with an embodiment of the present invention, a diagram is shown that schematically illustrates variations in distance R from the spindle center to each servo sector and variations in the servo-sector time interval TS. Those variations are caused by disk shift. In disk shift, the servo-sector interval varies in a sine curve synchronized with disk rotation. The variations in the servo-sector interval caused by rotational fluctuations at low temperature (not shown) are not synchronized with disk rotations and show smaller variations. Thus, basically, the servo-sector interval shows cyclic variations synchronized with disk rotation as shown in FIG. 7.

The servo-sector interval TS alternately increases and decreases. In an embodiment of the present invention, the servo-gate timing can follow the variations in an efficient manner; and, moreover, an improper timing adjustment does not cause a servo error, for example, a SAM detection error. HDC/MPU 23 delays, or advances, the servo-gate timing depending on the variation in the regions where the time interval TS between servo sectors continues to abruptly increase, or decrease, which correspond to the regions L in FIG. 7. Thus, in an embodiment of the present invention, the variations in the servo-sector interval can be followed for accurate reading of servo data. On the other hand, in the regions where the variation in the servo-sector interval TS is small, in particular, the regions where the direction of the variations changes from an increase to a decrease, or from a decrease to an increase, which correspond to the regions S in FIG. 7, the servo-gate timing is maintained to avoid a servo error caused by a failure in timing adjustment.

In the control described with reference to FIG. 6, if the servo-sector interval TS continues to increase at a higher increasing rate than a specific rate, the count value reaches the positive threshold, so that HDC/MPU 23 delays the servo-gate timing. If the servo-sector interval TS continues to decrease at a higher decreasing rate than a specific rate, the count value reaches the negative threshold, so that HDC/MPU 23 advances the servo-gate timing. In this way, HDC/MPU 23 adjusts the servo-gate timing in the regions where the servo-sector interval TS abruptly increases, or decreases, more than the thresholds.

On the other hand, if the variation in the servo-sector interval TS between adjacent sectors is within a specific range, which correspond to ranges in the zone Z0, HDC/MPU 23 does not modify the servo-gate timing. For small variations, the tracking can be secured even if the servo-gate timing is maintained; and, a servo error by a servo-gate timing change is avoided, so that the reliability in servo-timing control can be enhanced. Moreover, HDC/MPU 23 adds increased counts and decreased counts in the servo-sector interval TS to maintain the current value without changing the servo-gate timing in the regions around changes between an increase and a decrease. Thus, in an embodiment of the present invention, the reliability of servo-timing control can be enhanced.

In this way, in one embodiment of the present invention, if the variation in the servo-sector interval TS is small, which corresponds to ranges within the zone Z0, the count value is maintained and reliability is increased; but, depending on the design, the zone Z0 may be omitted so that the count value may be changed in accordance with only an increase, or a decrease, in the variation. Alternatively, HDC/MPU 23 may have two counters corresponding to an increase and a decrease in servo-sector interval TS. HDC/MPU 23 may manipulate the corresponding counter in accordance with an increase, or a decrease, if the variation amount in the servo-sector interval is larger than a specific value, or alternatively, regardless of the variation amount. When the count value of one counter reaches the threshold, HDC/MPU 23 modifies the servo-gate timing.

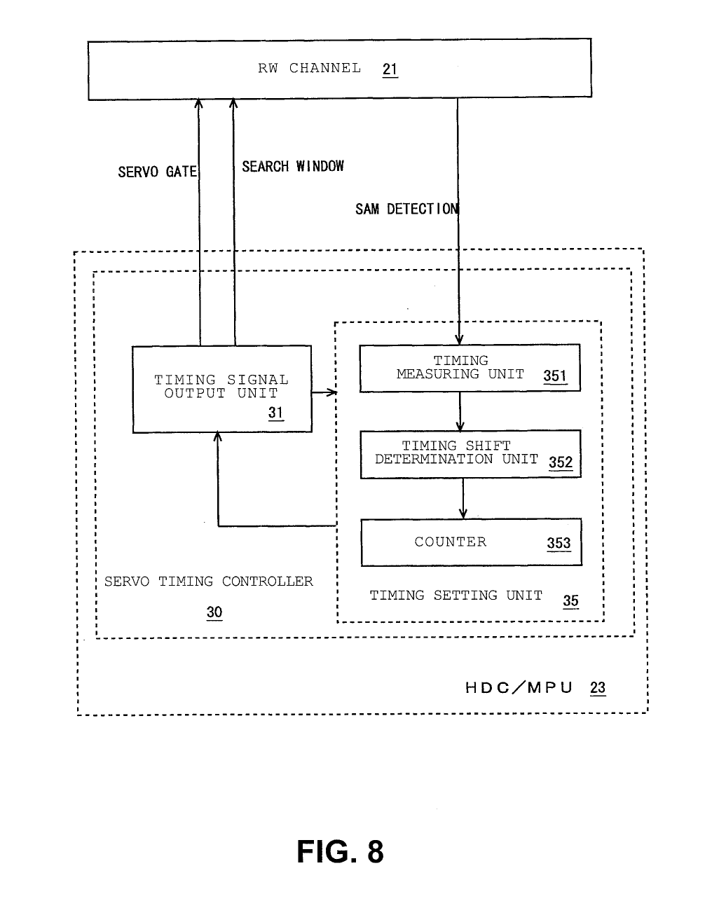

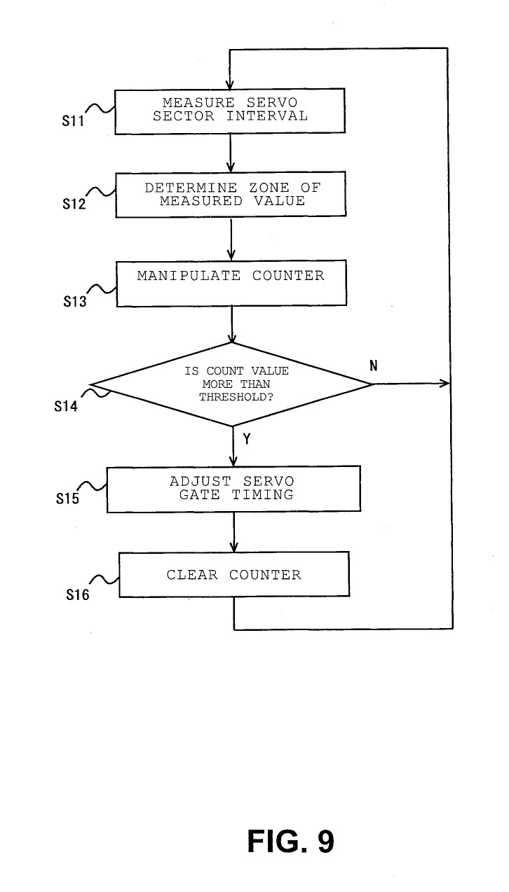

With reference now to the block diagram of FIG. 8 and the flowchart of FIG. 9, in accordance with embodiments of the present invention, a more specific servo-timing control method is next described. In FIG. 8, functional blocks within HDC/MPU 23 indicate the variations of HDC/MPU 23; the functional blocks can be implemented by circuits in the HDC and/or the MPU's operations in accordance with firmware. Alternatively, a portion of the functions of HDC/MPU 23 may also be implemented in RW channel 21. For example, RW channel 21 may perform the measurement of the servo-sector interval TS with reference to the SAM detection.

A servo-timing controller 30 controls operations of RW channel 21 with the servo gate SG and the search window SW. A timing-signal output unit 31 sends the servo gate SG and the search window SW to RW channel 21 in accordance with the setting of a timing-setting unit 35 and preset timing. RW channel 21 starts servo-data processing in accordance with the servo gate SG, and if a SAM is detected within a period indicated by the search window SW, RW channel 21 notifies the timing-setting unit 35 of the detection.

A timing-measuring unit 351 measures the time period T2_k from the servo-gate rising edge to the SAM detection for the current servo sector using the notification of the SAM detection from RW channel 21 and a clock signal to measure the servo-sector interval, at S11. A timing-shift determination unit 352 is a zone-determination unit and calculates the difference between the time period T2_k and the reference value T2_ref and determines which zone of Z0 to Z2 the result belongs to, at S12. At S13, the timing-shift determination unit 352 manipulates a counter 353 depending on the determined zone, which may be to increment, to decrement, or to maintain, the value of the counter 353.

The timing-setting unit 35 repeats the foregoing steps until the value of the counter 353 reaches the positive, or negative, threshold level (N-branch after S14). If the value of the counter 353 reaches the positive, or negative, threshold level (Y-branch after S14), the timing setting unit 35 instructs the timing-signal output unit 31 to adjust the timing of the rising edge of the servo gate SG, at S15. Specifically, the timing setting unit 35 instructs the timing-signal output unit 31 to advance the current timing of the rising edge by ΔT1 (T1_k−ΔT1), or alternatively, to delay the current timing of the rising edge by ΔT1 (T1_k+ΔT1).

If the servo-timing controller 30 has changed the servo-gate timing, the servo-timing controller 30 clears the counter 353 and sets the counter to the initial value, at S16. The servo-timing controller 30 repeats these steps in a write operation, or a tracking operation, during a standby to perform servo-data detection in reading, and writing, user data more accurately. In one embodiment of the present invention, the configuration in the above description uses three zones Z0 to Z2 for measured servo-sector intervals. In contrast, in another embodiment of the present invention, more zones facilitate the tracking of variations in servo-sector intervals, as is next described.

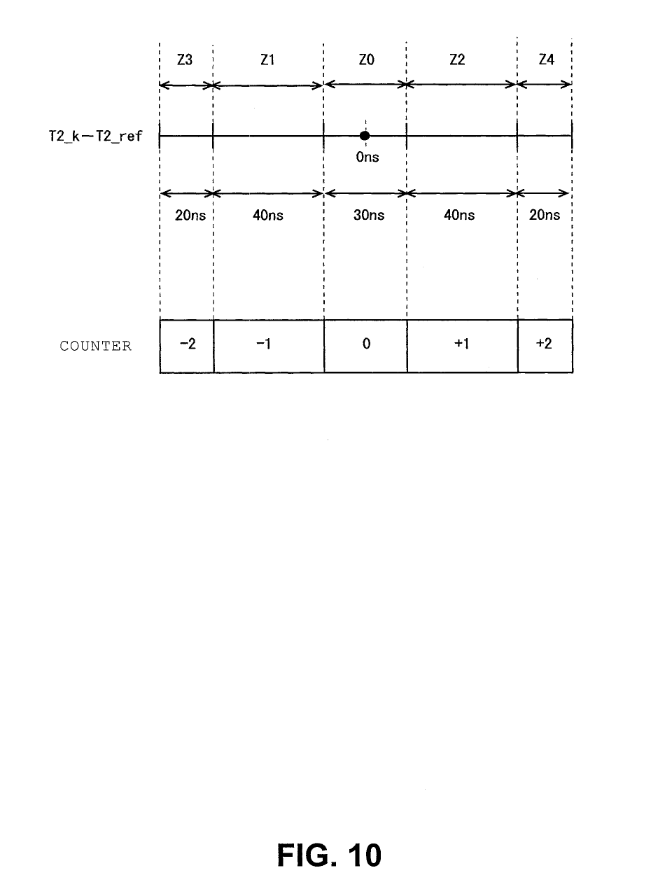

With reference now to FIG. 10, in accordance with an embodiment of the present invention, an example is shown in which HDC/MPU 23, including the timing-shift determination unit 352, uses five zones Z0 to Z4. In the configuration of FIG. 10, zones Z3 and Z4 are added to the zones previously described with reference to FIG. 6. To the zones Z3 and Z4, greater absolute values of the difference (T2_k−T2_ref) have been assigned; and, the zones Z3 and Z4 are located farther than the zones Z1 and Z2 from the reference value. Moreover, these zones Z3 and Z4 are weighted more than the zones Z1 and Z2. Since a counter is used, the weighting is represented by the manipulated variable, which corresponds to an increment, or a decrement, of the counter. Specifically, the absolute value of the manipulated variable of the counter in the zones Z3 and Z4 is 2, which is greater than the absolute value 1 of the manipulated variable in the zones Z1 and Z2.

As described with reference to FIG. 7, the rate of change in servo-sector intervals varies. In one embodiment of the present invention, in regions showing abrupt changes the servo-gate timing is adjusted earlier. Accordingly, increasing the manipulated variable, which corresponds to the amount of an increment, or a decrement, of the counter with increased rate of change in servo-sector intervals can facilitate the tracking of timing of the variations in servo-sector intervals.

As described with reference to FIG. 6, in an embodiment of the present invention, the zones are symmetric between positives and negatives. In FIG. 10, the zones Z3 and Z4 have the same absolute values of the boundary values, corresponding to 55 ns, and 75 ns, from the difference 0 as the center; and, the absolute values of the counting values in the counter are also equal. In accordance with embodiments of the present invention, HDC/MPU 23 may use more than five zones; but, use of too many zones reduces the efficiency in processing.

In an embodiment of the present invention, in the regions where the variations in servo-sector intervals in one direction, which correspond to an increase, or a decrease, are abrupt, HDC/MPU 23 performs servo-gate timing adjustment earlier. Thus, in accordance with embodiments of the present invention, one method includes dynamic modification of the zones for defining the count value depending on the variations in measured servo-sector intervals. Methods to modify preset zones may include: addition and deletion of zones; change of the range of an existing zone; or both the addition and deletion of zones and the change of the range of an existing zone. For example, HDC/MPU 23 adds the differences (T2_k−T2_ref) between the measured T2_k's and the reference value T2_ref in the latest specific number of measurements, for example, three measurements. If the signs, which may be either positive, or negative, of all the differences are the same and the added result exceeds a specific threshold level, corresponding to condition A, HDC/MPU 23 uses the zone arrangement shown in FIG. 10. If the sign of any of the differences is different from the others or the added result is the specific threshold level or less, corresponding to condition B, HDC/MPU 23 uses the zone arrangement shown in FIG. 6.

With further reference to FIG. 10, in accordance with an embodiment of the present invention, alternatively, in the zone arrangement shown in FIG. 10, HDC/MPU 23 may adjust the ranges of the zones Z1 to Z4 depending on the variations in servo-sector intervals. For example, under the above-described condition A, HDC/MPU 23 uses ranges, for example, 30 ns, in the zones Z3 and Z4 and ranges, for example, 30 ns, in the zones Z1 and Z2. Under the above-described condition B, HDC/MPU 23 uses narrower ranges, for example, 20 ns, in the zones Z3 and Z4 and wider ranges, for example, 40 ns, in the zones Z1 and Z2. In this way, modification of the zones which are the references for the determination of counter manipulation depending on the variations in servo-sector intervals facilitates tracking of servo-data detection timing corresponding to servo-sector variations.

In the description set forth above, the amount in adjusting the servo-gate timing is a fixed value ΔT1 per adjustment. This amount of adjustment may be modified. A large amount of adjustment in a region which shows large variations in servo-sector intervals with the same sign, which correspond to an increase, or a decrease, can facilitate the tracking. The method of determining the variation in servo-sector interval may be the same as the one in the adjustment of the zones, which are the zones for determination of the counter manipulation. For more precise control, three or more zones whose values are to be added are prepared for the references in determining the amount of adjustment and an individual amount of adjustment is assigned to each zone.

As set forth above, embodiments of the present invention have been described by way of examples but are not limited to the above-described examples. A person skilled in the art can easily modify, add, and convert each element in the above-described examples within the spirit and scope embodiments of the present invention. For example, in addition to a HDD, embodiments of the present invention can be applied to a disk drive using other types of rotating disks.

In the above description, in accordance with embodiments of the present invention, the time interval between a rising edge, or the servo gate, and SAM detection is measured to measure the time intervals between servo sectors; but, SAM detection in two servo sectors may be directly compared to measure the time intervals between the servo sectors. In this case, the reference value to be compared with the measured value is adjusted so as to conform to the adjustment in servo-gate timing. In accordance with embodiments of the present invention, other operations are the same as in the above-described operations. The timing control for servo-data detection of embodiments of the present invention may modify only the search window without modifying the servo gate.

The foregoing descriptions of specific embodiments of the present invention have been presented for purposes of illustration and description. They are not intended to be exhaustive or to limit the invention to the precise forms disclosed, and many modifications and variations are possible in light of the above teaching. The embodiments described herein were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method of timing control for servo-data detection in a disk drive, comprising:
retrieving a plurality of servo sectors arranged discretely in a circumferential direction of a disk and measuring time intervals between servo sectors;
determining in which zone of a plurality of preset zones each of said measured time intervals is included; and
determining variations in time intervals from said zones of a plurality of previous time intervals, and modifying timing for servo-sector detection if variations in time intervals are within a preset range.

2. The method of claim 1, wherein said modifying said timing further comprises modifying said start time of retrieving a servo sector.

3. The method of claim 2, wherein a time interval between servo sectors is measured by measuring said time period between said start time of retrieving a servo sector and detection of a specific signal in said servo sector.

4. The method of claim 1, wherein said plurality of zones comprise a negative zone where said difference between each value and a reference value is in a negative value range, and a positive zone where said difference between each value and a reference value is in a positive value range; and said variations in time intervals are determined from a number of times that said time intervals are included in said negative zone and said number of times that said time intervals are included in said positive zone.

5. The method of claim 4, wherein said plurality of zones comprise a zone zero which is defined by a value whose difference from said reference value is positive and a value whose difference from said reference value is negative; and a variation in a time interval is neglected if said measured time interval is included in said zone zero.

6. The method of claim 4, wherein if a measured time interval is included in said positive zone, a count is made in one of a direction selected from the group consisting of a direction of an increment and a direction of a decrement; if a measured time interval is included in said negative zone, a count is made in said other direction to a direction selected if a measured time interval is included in said positive zone; and if a measured time interval is included in said zone zero, counting is skipped; and if said count value reaches a preset value in said one direction, said timing is delayed; and if said count value reaches a preset value in said other direction, said timing is advanced.

7. The method of claim 4, wherein said plurality of zones comprise a negative zone where said difference between each value and a reference value is in a negative value range and a positive zone where said difference between each value and a reference value is in a positive value range; zones disposed farther from said reference value are weighted more; and said variations in time intervals are determined from said number of times measured time intervals are included in each zone, and from a weight.

8. The method of claim 1, further comprising:
determining a rate of change in time intervals from a plurality of measured time intervals; and
modifying said preset zones in accordance with a result of said determining.

9. A disk drive comprising:
a disk having a plurality of servo sectors arranged discretely in a circumferential direction;
a head for retrieving said servo sectors from said disk;
a measuring unit for measuring a time interval between servo sectors read by said head;
a zone-determination unit for determining in which zone of a plurality of preset zones said time interval measured by said measuring unit is included; and
a timing-adjustment unit for determining variations in time intervals from said zones of a plurality of previous time intervals, and for modifying timing for servo-sector detection if said variations in time intervals are within a preset range.

10. The disk drive of claim 9, wherein said timing-adjustment unit for modifying said timing is configured to modify said start time of retrieving a servo sector.

11. The disk drive of claim 10, wherein said measuring unit is configured to measure a time interval between servo sectors by measuring a time period between said start time of retrieving said servo sector and detection of a specific signal in said servo sector.

12. The disk drive of claim 9, wherein said plurality of zones comprise a negative zone where a difference from a reference value is in a negative value range and a positive zone where a difference from a reference value is in a positive value range; and said timing-adjustment unit is configured to determine said variations in time intervals from a number of times said time intervals are included in said negative zone, and said number of times said time intervals are included in said positive zone.

13. The disk drive of claim 12, wherein said plurality of zones comprise a zone zero which is defined by a value whose difference from said reference value is positive and a value whose difference from said reference value is negative; and said timing-adjustment unit is configured to neglect a variation in a time interval if said measured time interval is included in said zone zero.

14. The disk drive of claim 12, wherein if said measured time interval is included in said positive zone, said zone-determination unit is configured to make a count in one of a direction selected from the group consisting of a direction of an increment and a direction of a decrement; if said measured time interval is included in said negative zone, said zone-determination unit is configured to make a count in said other direction to a direction selected if a measured time interval is included in said positive zone; and if said measured time interval is included in a zone zero, said zone-determination unit is configured to skip making a count; and
if said count value reaches a preset value in a direction selected if a measured time interval is included in said positive zone, said timing-adjustment unit is configured to delay said timing; and if said count value reaches a preset value in said other direction to a direction selected if a measured time interval is included in said positive zone, said timing-adjustment unit is configured to advance said timing.

15. The disk drive of claim 12, wherein said plurality of zones comprise a plurality of negative zones where a difference from a reference value is in a negative value range and a plurality of positive zones where a difference from a reference value is in a positive value range; and a zone disposed farther from said reference value is more weighted;
said timing-adjustment unit is configured to determine said variations in time intervals from said number of times said measured time intervals are included in each zone and a weight.

16. The disk drive of claim 9, further comprising:
a zone-modification unit for determining a rate of change in time interval from a plurality of measured time intervals and for modifying said preset zone in accordance with a result of said determining.
